(19) United States
(12) Patent Application Publication
(10) Pub. No.: US 2011/0250356 A1
(43) Pub. Date: Oct. 13, 2011

(54) PROCESS FOR EFFICIENT PRODUCTION OF BAS RELIEF PHOTO CARVINGS IN SOLID SURFACE MATERIALS

(76) Inventors: John Tavone, Fort Lauderdale, FL (US); Patrick Michael Toomey, Kissimmee, FL (US); Andrew Sweet, Warwick, RI (US)

(21) Appl. No.: 12/758,474

(22) Filed: Apr. 12, 2010

(51) Int. Cl. B05D 3/12; B05D 1/36

(52) U.S. Cl. 427/264; 427/271; 427/277

(57) ABSTRACT

Disclosed are a process for the efficient production of bas relief art, e.g., photo carvings, in a solid surface material for various uses, including for jewelry, and processes to provide a finished product of a certain desired quality, e.g., staining and finishing techniques.

The term “Bas Relief” is a French term which means “low raised work,” and it is a type of sculpting art that is between flat and three dimensional. Normally, the work is observed from the front thereof bearing the raised work, including from various angles, while true three dimensional sculptures are normally viewable from any direction.

Bas relief art has many forms, shapes, textures, includes various topological forms, line depths, and can be of many sizes. Examples represent temple sculptures along the walls of churches, etc, to tiny pieces of sculpted art, for example, in jewelry, e.g., pendants. It has been and can be formed of many materials, including various stones and minerals, e.g., sandstone, limestone, alabaster, marble, wood, clay, plastics, acrylics, metals, hybrid materials, e.g., of plastics and glass, etc., and pretty much can be formed from all solid materials usable to form statues and other three dimensional forms. Some bas relief art is further enhanced by the use of coloring, shading, staining, texturing, sanding, and other finishing processes.

Typically forming bas relief art takes a very long time and painstaking effort from the artist sculpting and finishing a single piece of art, sometimes through several days or even years.

An object of the present invention is to provide a process for the efficient production of bas relief art, e.g., photo carvings (meaning an art in bas relief that corresponds to a photo, for example, of a portrait of a person, animal or scenery), in a solid surface material for various uses, including, but not limited to jewelry.

Another object of the present invention, in conjunction with or independently of the object mentioned above, is to provide processes to achieve a finished product of a certain desired quality, e.g., by staining and various finishing techniques, e.g., buffing. Examples of art formed by the processes of the present invention are depicted in the figures, although they are not limited to such uses, sizes or shapes.

In an aspect, the present invention includes the customized, yet efficient, production of a single piece of art, for example, for use in jewelry, e.g., as a pendant, or many pieces thereof, in response to a request by a customer wishing to have a desired image, for example, of family members, engraved in said pendant.

In sum, the process involves the production of carved images based on a photograph or image, which is in part automated by the use of modern techniques by the use of modern tools, e.g., computers and software, and machinery capable of following the guidance provided by such computers and software, and/or modern finishing steps, e.g., buffing and/or sealing the obtained product, e.g., by dyes and lacquers.

The process includes converting a digital photograph to a high dynamic range black and white image. The original photo (source) in this regard is converted to a color image, e.g., 48 bit color image, and processed using software, e.g., a smart surface blur algorithm, to smooth continuous tone areas such as skin. The source is also processed using software, e.g., a dust and scratch removal algorithm to remove isolated noise such as small blemishes, highlights on glasses, scratches on original photo or negative, etc. Thereafter the source is converted to a black and white image, e.g., a 16 bit black and white image, and contrast corrected to maximize dynamic range. The algorithm can be a tool in a graphics software package selected and used by a person on the image or part thereof.

The resulting image is converted to a height map where darker areas of the image are lower height values and lighter areas are higher height values.

The height map is processed by using software to produce a corrected height map allowing for a ballmill cutter to reach optimal cutting depth without intruding into higher neighboring areas. This allows for maximized detail in the final cut without sacrificing depth and therefore final color contrast.

The height map is projected onto an underlying solid surface material shape such as a domed or flat jewelry blank and a final toolpath is generated.

The toolpath is sent to machining equipment, for example, to CNC machining equipment, and is cut into a solid surface material. For jewelry applications, for example, it has been found that various acrylic solid surfaces, polyester solid surfaces and acrylic/polyester blend solid surfaces are advantageously useful, although other materials may be used as well. Examples are the following products, AVONITE®, which includes both the Avonite Studio collection product, which is a polyester solid-surface material, and the Avonite Foundations collection product, which is an acrylic solid surface material, DOVAE®, DuPont CORIAN® (containing acrylic polymer and alumina trihydrate), FORMICA Solid Surface®, HANEX® (100% Acrylic Solid Surface), LG HI-MACS® (containing 70% of bauxite, 25% of acrylic and 5% of pigment), MEGANITE® (100% acrylic solid surface material consisting of PMMA (methyl methacrylate) and natural aluminum trihydrate filler), MYSTERA®, Samsung STARON®, Wilsonart EARTHSTONE®, and Wilsonart GIBRALTAR® and other similar products. Many of these products resemble stones or gemstones or glassy surfaces. As such, many of these products are typically also used in the kitchen/bathroom countertop industry. Any such materials useful in said industries are useful to be processed in accord with the processes disclosed herein. Further suitable materials are other plastic and resin materials, such as urethane resin plastics such as SMOOTH-CAST® from Smooth-On, and other similar products.

The achieved product is then colored, preferably sprayed with a dye capable of etching several microns into the solid surface material, but no further.

The product is buffed, which can be achieved by using a variety of materials, to remove dye from higher areas of product while leaving dye intact in lower areas. This produces the final photographic look of the piece with lighter and darker tones. The buffing materials and techniques enhance the continuous tone photographic look of the final product.

Finally, the product is preferably sealed with a clear coat material as a sealant and protectant.

The process disclosed herein thus includes:
Image is converted to digital format if necessary
Height map is produced
Toolpath is generated from height map
CNC machine cuts image
Dye is sprayed on carving and
Dye is buffed off high points and details of carving.

In a preferred embodiment, the process for the efficient production of bas relief photo carvings in solid surface material includes the following aspects.

A photograph is scanned or otherwise converted to a digital format, if necessary (that is if the starting photograph was not already in a digital format), which digital photograph is identified hereinafter as the “image.”

There is no limitation on the exact software or algorithm in any of the process steps as long as they achieve the desired goal(s) of said steps.

In a preferred embodiment, the following steps are performed in Photoshop CS4 or similar digital image editing software.
Image is cropped to the same aspect ratio as the final desired carving.
Image is converted to 16 bit RGB format.
A digital filter is applied to remove flaws in the image such as dust and scratches and typically a human operator adjusts the settings to maximize image quality. For example, in Photoshop CS4: Filter->Noise->Dust and Scratches, tools are useful to achieve a maximized image quality. The purpose of this step is to remove small very high contrast areas of pixels. In other words, several very light pixels on a very dark background would be removed, and/or small areas of very dark pixels would be removed from light backgrounds.
Image is converted to black and white by discarding color information. In Photoshop CS4: Image->Adjustments->Desaturate, tools are useful in this regard.
Image is adjusted for maximum contrast. In Photoshop CS4: Image->Auto Contrast, tools are useful in this regard.
Areas of image with low contrast are blurred while maintaining sharpness at high contrast boundries. In Photoshop CS4: Filter->Blur->Surface Blur, tools are useful in this regard. Typically a human operator adjusts the settings of the blur filter to maximize image quality.
Image is saved, for example, in TIFF format. The following settings have been found useful: 16 bit-RGB-LZW Compression-No Layers.

The next series of steps is performed, for example, in Delcam ArtCam Pro 2008, or similar CAM software:
Open image file from previous steps as a new bitmap layer.
Create new relief layer from bitmap with the relief height set using the following preferred formula . . . Height (in inches)=Longest Image Edge Length (in inches)*0.0125+0.0225. For example, a 1.25″×0.75″ image would have a relief height (rounded to the nearest 1/1000″) of 1.25 *0.0125+0.0225=0.038″ Deviations from this formula is within the scope of the present invention.
A relief toolpath is created, for example, using the following settings, which are not limiting:

Strategy: Raster

Raster Angle: 0

Allowance: 0.001

Tolerance: 0.001

Tool: Ballnose—size depends on size of finished carving . . . . For example, the following are preferred sizes
Carvings up to 2″=0.015″ Ballnose bit
Carvings 2″-4″=0.047 Ballnose bit
Carvings 4″-6″=0.078 Ballnose bit
Carvings over 6″=0.125 Ballnose bit
Stepover: Bit size*0.1
Stepdown: Same as relief height
Feed Rate: Bit size (in inches)*1000 inches per minute
Plunge Rate: Same as feedrate
Toolpath for the relief carving is exported for the CNC machine to be used.

The toolpath is cut on, for example, a CNC router or mill into a solid surface material, for example, an acrylic solid surface material such as CORIAN®, HANEX® or STARON®.

It is to be understood that the above selected settings and values can be changed, independently of each other, as desired depending on the desired results, e.g., by ±50%, ±40%, ±30%, ±20%, ±10%, ±5%, ±2%, ±1% of any value given above.

The finishing steps include taking the carved image product created, for example, by steps described above and spraying it with a solvent based dye, for example, a color-fast acetone based dye, for example, an acetone based wood dye, such as a MICROTON DYE® from M.L. Campbell Company. Also useful is a universal tint concentrate such as MIXOL® mixed in a solvent carrier such as an acetone carrier. This product is compatible with just about any solvent system. Preferred dyes are typically fast drying, e.g., in a couple of minutes or less.
Dye is sprayed at room temperature in a humidity controlled environment using an HVLP spray gun with fine atomization. Preferred parameters are, although not limiting, for example:
Spray distance is 4-6 inches
Spray pattern is 4 inches wide
Spray volume is low
Spray rate is fast to prevent puddling of the solvent in the dye which would create mottled surface coloring
Coverage is full to completely color carving to maximum darkness of dye color being used. Too little dye will result in low contrast.
Care must be taken to spray from many angles to color all carved edges from all sides.

The dye is allowed to dry for typically about 60 seconds or more (no maximum time is specified since the dye carrier solvent flashes off in this time and will no longer react with or penetrate the solid surface material).

The dye is buffed off of the high parts of the bas relief carving leaving high points the color of the solid surface material and low points the color of the dye. Since a bas relief carving creates high points representing the lighter colors of the image and low points representing the darker colors of the image, a photographic image is recreated. The buffing process uses semi-flexible buffing media so medium depth areas are “feathered” in between the high and low points creating a range of colors and a photographic continuous tone image.

In a preferred embodiment, the dye is removed from the highlight areas of the carving (the highest elevations). Optionally, the surface is lightly wiped, e.g., hand wiped, utilizing a fine steel wool, for example, #0000 fine steel wool. After the highlights have been relieved of excess dye, the dye is removed from the intermediate levels of elevation using, for example, a fine fiber cloth, e.g., red 3M fiber cloth. Next, critical details are defined by removal of dye using tools that can be carefully controlled to remove dye selectively. Depending on the desired result, a tool is chosen from any of the following: a sharpened ink eraser, a broad gum eraser, a narrow gum eraser, an exacto knife, e.g., a #11 exacta knife, sharpened pen eraser, a pencil eraser, various grades of sandpaper, e.g., #600 sandpaper and an adjustable/retractable eraser pen, among other tools usable to remove dye. Each tool is preferably used in its appropriate application. For example, an exacto knife can be used to define the white of an eye, and a sharpened ink eraser to define eyelids and lips. One or skill in this art would be able to determine the proper tool for each desired result with little difficulty. Typically, the accuracy and critical interpretation of the image details is determined by the accompanying photograph as a reference to maintain the integrity of the provided image.

Alternate options include the automation of the above finishing steps, which include the use of vibratory deburring machines with various abrasive materials to eliminate at least the initial first hand removal of the dye, and possibly, upon changing the parameters or machines, even the intermediate levels. Such automation results in an even more efficient handling of larger volume production of product.

After the dye has been satisfactorily removed and the details have been clearly defined, a light coat of sealant, for example, acrylic lacquer, is preferably sprayed onto the surface to act as a sealant/barrier to protect the remaining dye from solvents in the lacquers to follow.

After the seal coat has dried, a first coat of a very hard and durable solvent based lacquer is preferably applied. Shortly after this coat dries, a second coat of lacquer is preferably applied. In a preferred embodiment, the second lacquer is identical to the first lacquer.

Optionally, further coats of lacquer may be applied. When the latter or latest coat is completely dry, a final coat of matt lacquer is optionally and preferably applied for visual appeal. Such a final coat imparts a rich, matt finish.

After final inspection, the carving is ready to be applied in its final application, that is, for example, to be set or used as a jewelry pendant, charm bracelet, buttons, pins, Brooches, Christmas ornament, paperweight, refrigerator magnet, any decorative surface or memorabilia, urn, trophy, and various other applications without any limitation.

### BRIEF DESCRIPTION OF DRAWINGS

FIG. 1 depicts the image or portrait of a boy in a jewelry setting,

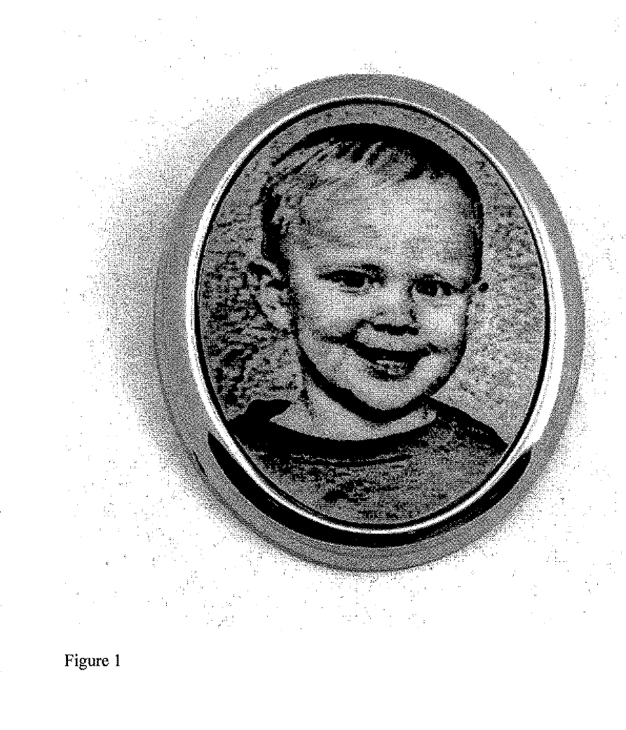

FIG. 2 depicts the image or portrait of a dog in a jewelry setting,

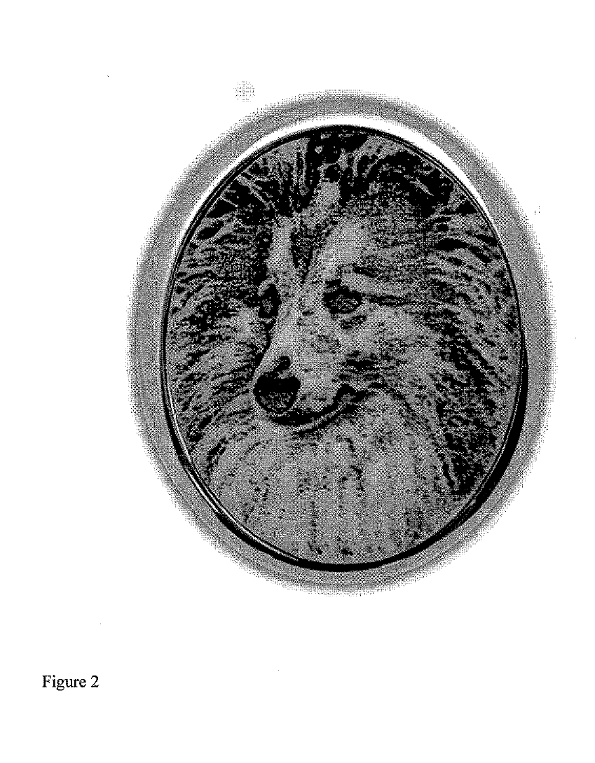

FIG. 3 depicts the image or portrait of children in jewelry settings used as charms on a bracelet, and

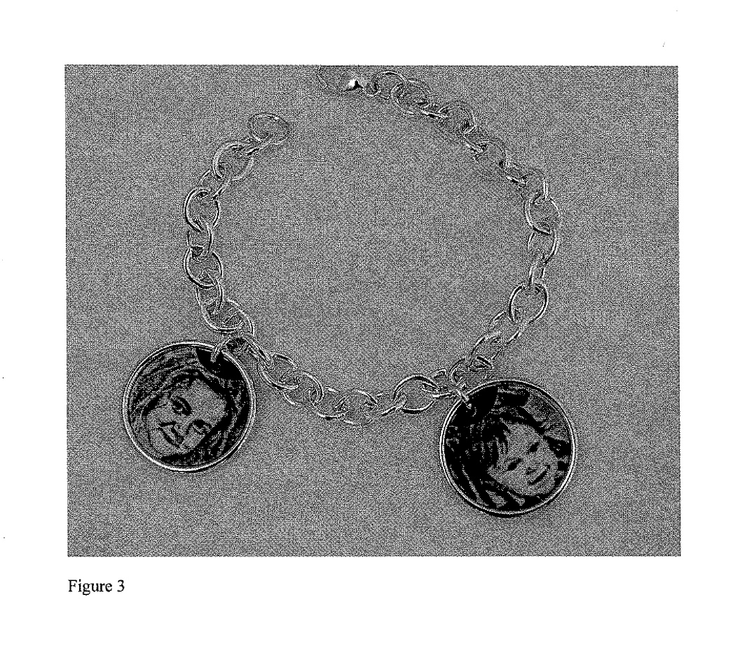

FIG. 4 depicts the image or portrait of children in jewelry settings used as pendants on a necklace.

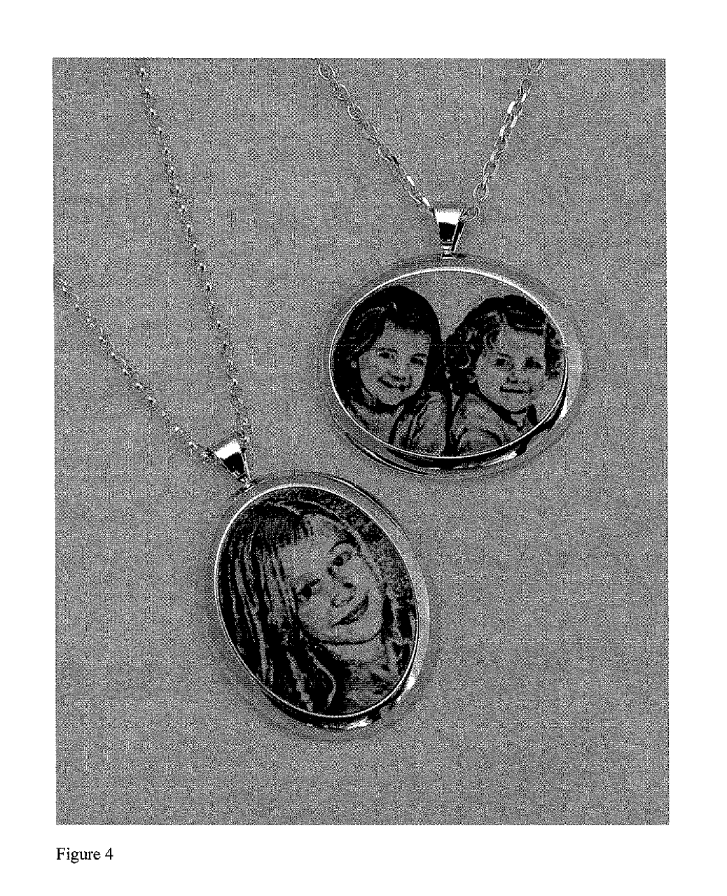

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

It is to be understood, that the processes disclosed herein are not limited by the order of their disclosures, and in certain situations, certain steps of the processes not desired or necessary in a given situation, may be excluded. For example, if an image does not contain blemishes, no reason is present for the elimination of blemishes. Also, if no critical details are present on the image, no attention to such is required. Yet, the invention herein includes such a process with the elimination of such steps.

The entire disclosures of all applications, patents and publications, cited herein are incorporated by reference herein.

The preceding examples, for example, of the products depicted in the figures, can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A process for preparing a bas relief carving from an image, comprising
spraying a dye onto a carving that has been produced by
producing a height map based on a digital image, and
cutting the image into a solid surface based on the height map,
wherein the dye is of a nature that it reacts with and/or penetrates the carving while drying to a depth sufficient that image enhancement buffing can be effected to reproduce the image.

2. A process for preparing a bas relief carving from an image, comprising
image enhancement buffing a carving to reproduce the image, which carving has been produced by
producing a height map based on a digital image, and
cutting the image into a solid surface based on the height map, and
spraying a dye onto the resultant carving,
wherein the dye is of a nature that it reacts with and/or penetrates the carving while drying to a depth sufficient that image enhancement buffing can be effected to reproduce the image.

3. A process according to claim 1, which further includes sealing the resultant carving with one or more layers of a lacquer and with a final coat of a matte lacquer.

4. A process according to claim 1, which further includes setting the resultant carving into jewelry.

5. A process according to claim 1, wherein the image is a photograph.

6. A process according to claim 1, wherein the dye is a solvent based wood dye.

7. A process according to claim 1, wherein the dye is an acetone based wood dye.

8. A process according to claim 1, wherein the solid surface is an acrylic solid surface, polyester solid surface or acrylic/polyester blend solid surface.

9. A process according to claim 1, which further comprises image enhancement buffing the carving to reproduce the image.

10. A process for preparing a bas relief carving from an image, comprising applying a dye to a carving based on an image in an acrylic solid surface, wherein the dye is of a nature that it reacts with and/or penetrates the carving while drying to a depth sufficient that image enhancement buffing can be effected to reproduce the image.

11. A process according to claim 1, wherein the carving has a longest image edge of up to 2 inches.

12. A process according to claim 1, wherein the carving has a longest image edge of up to 4 inches.

13. A process according to claim 1, wherein the carving has a longest image edge of up to 4 inches, wherein the solid surface is an acrylic solid surface, and wherein the dye is a solvent based wood dye.

14. A process according to claim 1, wherein the dye is sprayed at room temperature in a humidity controlled environment using an HVLP spray gun with fine atomization.

15. A process according to claim 14, wherein the parameters include:
spray distance is 4-6 inches
spray pattern is 4 inches wide
spray volume is low
spray rate is fast whereby puddling of the solvent in the dye is prevented
coverage is full to completely color carving to maximum darkness of dye color being used.

16. A process according to claim 2, wherein the dye is buffed off of the high parts of the bas relief carving leaving high points the color of the solid surface material and low points the color of the dye, wherein the buffing process uses semi-flexible buffing media so medium depth areas are feathered in between the high and low points creating a range of colors and a photographic continuous tone image.

17. A process according to claim 2, wherein the dye is removed from the highlight areas of the carving, the surface is lightly wiped with a fine steel wool, the dye is removed from the intermediate levels of elevation using a fine fiber cloth.

18. A process according to claim 2, wherein critical details of the image carved into the solid surface are defined by removal of dye by selective removal of dye.

19. A process according to claim 18, wherein the selective removal of dye is achieved by one or more of the following tools: a sharpened ink eraser, a broad gum eraser, a narrow gum eraser, an exacto knife, sharpened pen eraser, a pencil eraser, sandpaper, an adjustable/retractable eraser pen.

20. A process according to claim 2, wherein buffing the dye off from the carving is achieved by a vibratory deburring machine.
